(19) United States
(12) Patent Application Publication
(10) Pub. No.: US 2004/0083373 A1
(43) Pub. Date: Apr. 29, 2004

(54) Automatically generated cryptographic functions for renewable tamper resistant security systems

(76) Inventors: Gregory M. Perkins, Pennington, NJ (US); Zhijun He, Piscataway, NJ (US)

Correspondence Address: RATNERPRESTIA, P O BOX 980, VALLEY FORGE, PA, 19482-0980, US

(21) Appl. No.: 10/282,648

(22) Filed: Oct. 28, 2002

(51) Int. Cl. G06F 12/14

(52) U.S. Cl. 713/189

(57) ABSTRACT

A secure cryptographic function is generated from a template containing static program code that is the same for all mobile agents and dynamic program code which differs for each function. The dynamic code implements a stream cipher encryption algorithm that is used to encrypt messages processed by the function. The dynamic code may also generate a message digest that is attached to each message. The message digest may be a hash function applied to the dynamic code and, optionally, to the message. Each function may be assigned a limited lifetime, either by assigning it a fixed termination time, a maximum number of messages that it may send or, if the cryptographic function is used with a mobile agent, a maximum number of hosts that it may visit. Any received messages that have been processed by the encryption algorithm after the expiration of its lifetime are ignored.

### BACKGROUND OF THE INVENTION

The present invention relates to cryptographic functions used in computer systems and in particular, to automatically generated program instructions which are used to implement renewable, unique cryptographic functions.

Cryptographic functions have many applications in computer systems and even in general consumer applications. Program content distributed via media such as DVD's is encrypted to prevent unauthorized copying. Cryptographic functions are also used to authenticate a user of a computer system, to encode data stored on the computer, such as log files and audit trails to ensure the integrity of the stored data. These functions may also be used with mobile agents to establish a private communications channel between the agent and its principal. Because all software tamper-resistance techniques can be broken by attackers who have access to the protected content and sufficient time, it is desirable to provide a renewable cryptographic function to increase the effort needed to gain repeated access to protected content. Although the subject invention is described in the context of mobile agents, it is contemplated that it may be used with any of the content and in any of the systems described above to enhance the security of the encrypted data.

A mobile agent is an object that moves around a network, such as a global, wide area or local area network and executes in host computers (other than its originator.) There are two types of computer servers in an agent's lifetime: the producer and the consumer. The agent's producer, also known as the principal, creates and distributes the agents. The consumer is a server that executes the agent to perform certain tasks.

A shopping mobile agent, for example, may be written in a program language such as JAVA which may be executed on many different types of computers and then be used to find the lowest price of a product from among several Internet web pages. When creating an agent, the owner must first decide what task he wishes the agent to accomplish, such as shopping. Next, the owner must instruct the agent on how to accomplish the task, which includes how to migrate between servers and how to return results. Once these steps are completed, the agent is ready to be sent out onto the network. The mobile agent then moves among hosts (host computers) in the network autonomously and executes its program code on the hosts in order to achieve the purposes of the mobile agent's principal.

A mobile agent can also have an “awareness” or pseudo artificial intelligence and act autonomously of the principal. It may, for example, choose its own migration path though a network topology to seek out new hosts to complete its mission. A mobile agent may communicate with its source computer system or with other mobile agents to exchange and share information. It can also spawn other mobile agents or “bots” to assist the mobile agent. A bot is a program or a set of instructions that resides on a computer and sends out queries to other computers,

whereas a mobile agent includes commands or instructions that are executed on the host computer to which it has traveled and resides.

The security concerns of an agent owner are the privacy and integrity of the agent's data, code, and execution. A malicious consumer host may try, for various reasons, to access and alter an agent's private data or code. A large number and the different types of attacks made against agents make malicious hosts a serious problem. Eventually a determined attacker will compromise a mobile agent. The only question is how long it will take for an attacker to succeed.

One method to increase a mobile agent's security is to use tamper-proof hardware. This hardware, however, may be not available to everyone or available everywhere due to various resource and cost requirements. Furthermore, hardware can also be compromised and is not easily renewable. To improve the security of mobile agents, software protection is still desirable and, in many situations, may be the only available method.

Another security concern is the denial of execution. This problem occurs when a consumer refuses to execute an agent. Consider for example, a shopping agent arriving at a consumer host computer, the agent must first determine if it has arrived and is executing on the correct destination host. After the agent has authenticated that it has arrived at the correct consumer, the agent will start performing its task which is, typically, the collection and analysis of data from the consumer. Once this task is complete, the agent will decide on its next destination. The agent may migrate to another consumer or return the result to its principal and terminate.

Before and during the agent's execution, a malicious consumer may prevent the execution of the agent. The malicious host may then analyze the agent and may dislike the results obtained by the agent. For example, a shopping agent with a mission to order goods based on data it collects is sent to a malicious host. The host may terminate execution of the agent because the agent has found another host with better prices. Once execution ceases, the malicious host may modify the agent's result for its own benefit or the host may impersonate the agent. This allows the malicious host to return false information in order to make improper gains.

The malicious host may also try to analyze and compromise the agent. A malicious host may simply refuse or delay the execution of an agent because it wishes to compromise the agent by analyzing or reverse-engineering its program code. The objective of the malicious agent is to then modify the agent in a way that benefits the malicious host and then restart the execution of the agent. The malicious host can extract sensitive information from the agent which may include personal data such as names, credit card numbers and addresses.

Mobile agent developers and principals initially ignored these particular types of attacks because they were focusing on developing useful mobile agents and because it was thought that the developer could always detect a denial of execution because the principal would stop receiving communications from the agent. It was also wrongly assumed that the agent consumer host could not gain anything from the denial of agent execution. But, as described above, the consumer host has many reasons for denial of execution and as mobile agents become more popular, this problem will become more serious.

### SUMMARY OF THE INVENTION

The present invention is embodied in method for generating a cryptographic function by dynamically programming the function with a customized set of instructions which are different for each instance of the function. The customized instructions are produced from selected functions and operands and new sets of dynamic computer program instructions are then provided as a unique cryptographic function.

According to one aspect of the invention, the customized instructions implement an encryption algorithm.

According to another aspect of the invention, the encryption algorithm is a stream-cipher algorithm

According to yet another aspect of the present invention, a unique identifier is assigned to the function.

According to another aspect of the invention, the unique cryptographic function is implemented in a mobile agent.

According to yet another aspect of the present invention, an Agent Monitoring System (AMS) is used in conjunction with the unique mobile agent. The AMS monitors the status and the lifetime of the unique mobile agent. The agent is registered with the AMS and unique mobile agent information is stored in a database. The AMS establishes a communication protocol with the agent, thus allowing information exchange between the AMS and the agent. The AMS may also distribute a new agent at the end of the lifetime of a current agent to complete the agent's task or distribute and track multiple agents over a period of time, replacing each of the concurrently executing agents as its lifetime expires.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a network block diagram which is useful for describing the production and the migration of a mobile agent according to the present invention

FIG. 2 is a functional block diagram showing the components of the mobile agent.

FIG. 3 is another network block diagram which is useful for describing the migration of an agent through its lifecycle as it travels across several hosts.

### DETAILED DESCRIPTION OF THE INVENTION

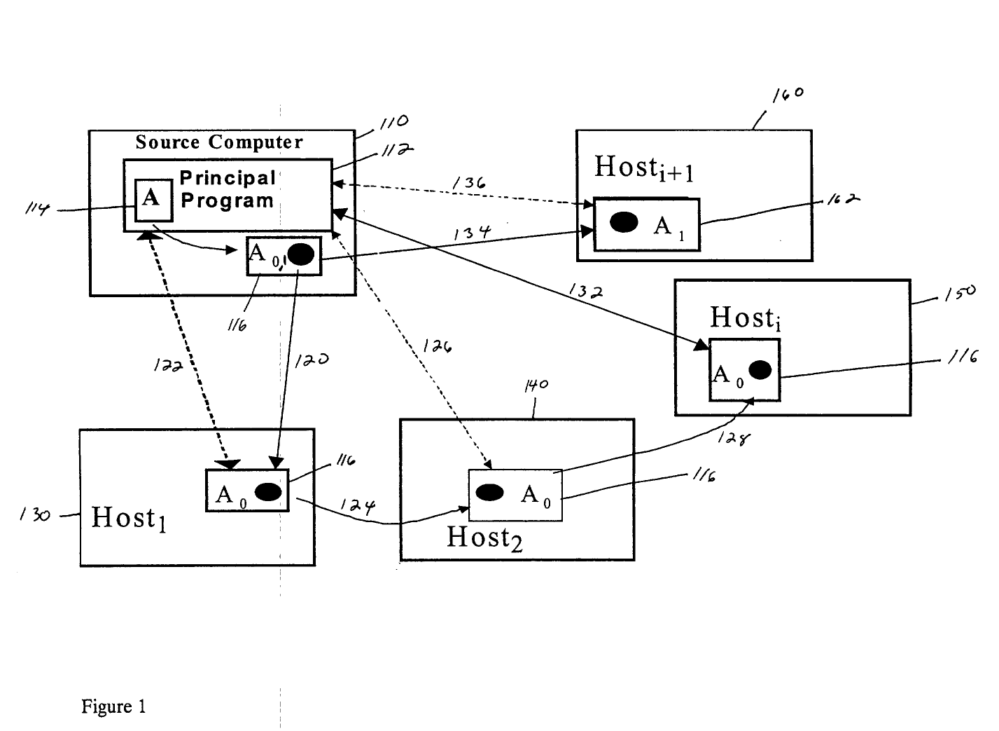

FIG. 1 is a network block diagram showing the life cycle and the migration of a mobile agent through several host consumer computers. The mobile agent is produced by a principal program 112, which is executed on the source computer 110. Although the principal is usually a person, it is shown as principal program 112 and this program is used by a person to initiate and communicate with the mobile agent.

To generate a mobile agent the principal program 112 uses an agent template 114. In this example, mobile agent A₀ 116 is the first mobile agent produced from the agent template 114. Mobile agent A₀ 116 is then sent to the first consumer Host_{—}1 130 by way of a network communication path 120. After arriving at consumer Host_{—}1 130, mobile agent A₀ 116 executes on Host_{—}1 and communicates with principal 112 via the network path 122. Upon completion of its task on Host_{—}1 130, mobile agent A₀ 116 travels via the network path 124 to Host_{—}2 140. After arriving at Host_{—}2 140, mobile agent A₀ 116 again executes and communicates over the network path 126 with the principal 112. When an agent terminates itself, it may be desirable for the agent to first upload, to the principal 112, any data that it has collected and to inform the principal that it is terminating so that the principal may generate a new agent to complete the task.

Mobile agent A₀ 116 is also assigned a limited lifetime. It continues its mission as long as its lifetime has not expired and it has not been destroyed. In the exemplary embodiment of the invention, the lifetime of the agent may be determined by the static program code, in which case, each mobile agent would have the same limited lifetime. Alternatively, the lifetime may be determined by the dynamic program code and each agent may be assigned a random lifetime selected from within a predetermined range. The lifetime may be an amount of time or it may be a number of hosts that the agent is allowed to visit. When the agent exceeds its lifetime, it may terminate itself or it may be terminated by the principal 112.

In this example, at consumer Host_i 150, the mobile agent A₀ 116 exceeds its proscribed lifetime and terminates itself. The principal 112 becomes aware of this and creates a new mobile agent A₁ 162, also based on the same agent template 114 but having different dynamic code than agent 116. The principal 112 sends this new mobile agent A₁ 162 to Host_i+1 160 via the network path 134 to continue the mobile agent's task. Agent A₁ 162 continues the mission of the principal 112 until its lifetime expires. If agent A₁ 162 lifetime expires before completion of mission, principal 112 creates other agents individually (A₂, A₃, etc. . . . ) to finish the undertaking. Each agent has different dynamic code.

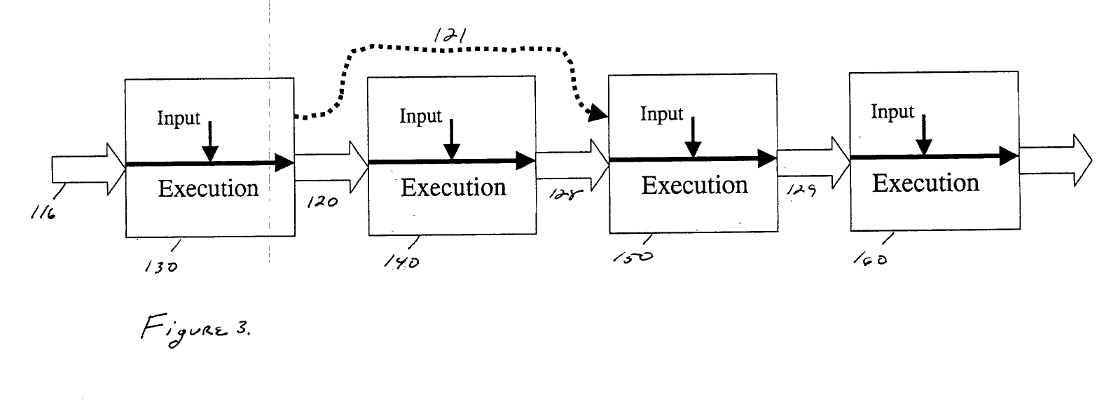

FIG. 3 is a network block diagram showing how the mobile agent travels or migrates across hosts. The mobile agent A₀ 116 is created by the principal 112 and sent to the first Host_{—}1 130. Here the agent executes code on the host and may gather some data. This data, can be stored in the mobile agent A₀ 116. The data, can also be sent back to the principal 112 or to an Agent Monitoring System (AMS) described below. The AMS is a software program that may use a database to monitor the status of mobile agents. The AMS or the principal 112 may instruct the mobile agent A₀ 116 to go immediately to Host_i 150, bypassing Hosts_{—}2 140, as shown by the dashed arrow 121. Alternatively, the agent may operate autonomously and visit the respective host 130, 140, 150 and 160 in sequence.

If mobile agent A₀ 116 is performing in an autonomous mode, the agent decides for itself, based upon data it has collected, to move to Host_{—}2 140 or hop immediately to Host_i 150, bypassing Hosts_{—}2 140, as shown by the dashed arrow 121. If the agent is not in autonomous mode, it may wait for instructions from the principal 110 or from the AMS.

A poorly performing network may also impede the agent's ability to perform its function. In this exemplary embodiment, the principal 112 or the AMS determines whether to wait an additional amount of time for the network performance to improve, or to launch an additional mobile agent to complete the assigned task. The AMS or principal 112 can “ping” the host consumer where the mobile agent is situated and determine if there are any network propagation delays. A “ping” is a program used to test reachability of destinations by sending them one, or repeated, ICMP (Internet Control Message Protocol) echo requests and waiting for replies.

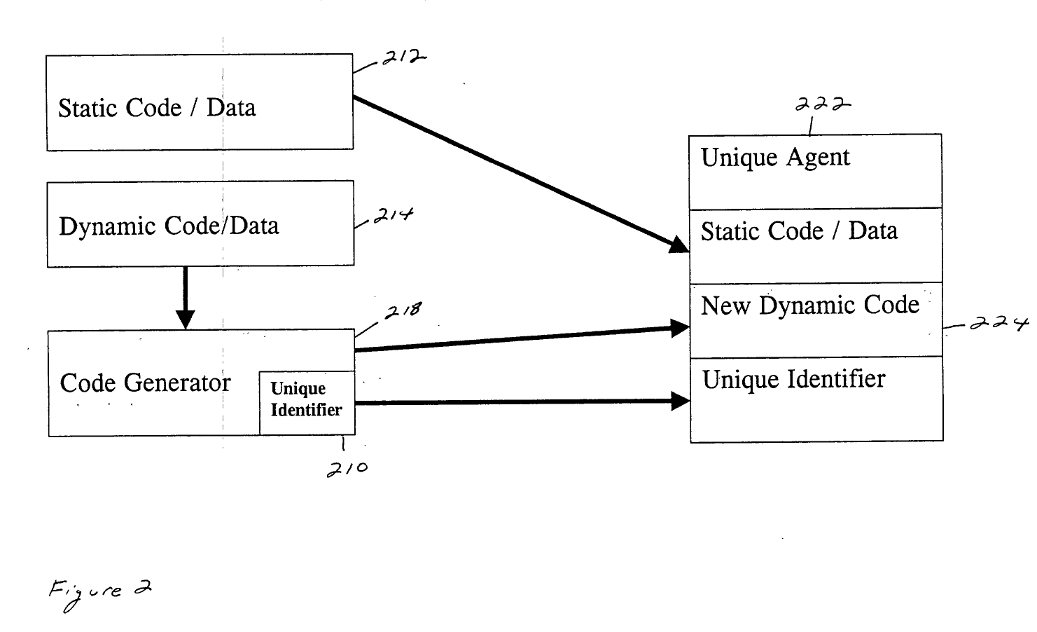

FIG. 2 is a model that shows the components that may constitute the new unique agent's template. The agent template has two parts: (1) the static code and data 212 and (2) the dynamic code and data 214. The static code and data 212 are placed unmodified into the new program code of the mobile agent 222 directly. The dynamic code and data 214 is first passed into a code generator 218 to produce new dynamic code 224 which also becomes part of the new unique agent 222. In the exemplary embodiment, the code generator 218 may also produce the unique identifier 210 which is different for each unique agent.

In the exemplary embodiment of the invention, the unique identifier is associated with the dynamic code assigned to the agent. The unique identifier is sent by the agent with each message that it sends to the principal. Based on this message, the principal knows the dynamic code used by the agent and can properly decode or verify any message received from the agent.

As stated previously, complete automatic code generation is inherently difficult and, in the exemplary embodiment, the solution to this problem is to automatically generate only the cryptographic functions. This is advantageous because mathematical functions are easier to automatically generate than arbitrary code. Cryptographic functions are important for security in that they can be used to encrypt and decrypt the agent's private data.

A unique mobile agent according to an exemplary embodiment of the present invention, uses a stream cipher as the encryption function. Stream ciphers are feasible for software encryption because the combination of two or more stream cipher functions is at least as secure as the strongest cipher of the group of combined ciphers. Thus, the combination of an existing cipher, for example, a block cipher such as DES, with another cipher to form a stream cipher results in encoding that is at least as strong as DES.

The basic concept of the stream cipher is to use a key stream (Z=Z₁, Z₂ . . . ) to encrypt the dynamic code and data 214 in the random code generator 216. The “current” (ith) key, Zᵢ is generated based on the previous key Zᵢ₋₁ and the “current” dynamic code and data 214 and is shown as equation (1).

xᵢ₋₁:zᵢ=f(zᵢ₋₁,xᵢ₋₁) (1)

The new dynamic code 220 yᵢ is generated by the “current” ith key zᵢ and the encryption function is shown in equation (2).

yᵢ=e_{zi}(xᵢ) (2)

Computing the inverse of the functions used during the encryption performs decryption. Dynamic code and data 214 is then regenerated by the ith key zᵢ and the inverse of the encryption function, as shown in equation (3).

xᵢ=d_{zi}(yᵢ) (3)

To facilitate the automatic construction of a multi-functioned stream cipher, the exemplary embodiment of the invention employs a stream cipher code template as the basis of the code generation engine 218. New code is generated based upon the structure of the template and in the exemplary implementation the template is written in Java and consists of two parts: the static part and the dynamic part. The static portion consists of the Java code that appears in every generated instance. The dynamic portion is parsed from the static portions and is identified through the use of a set of tags. The tags in the exemplary embodiment, are the angle brackets “<” and “>”. The tags are then replaced by new, dynamically generated code. Therefore, the template is a piece of data that is used by our code generation engine to automatically build new code.

A part of the stream cipher template is shown as pseudo code in table 1. In this template, the functions to calculate the internal states (S-Box), encryption and decryption are represented by tags. The functions are randomly generated for each code instance.

TABLE 1
//definition of unary and binary operations, such as plus, squaresum, xor,
swap.
<DEFINITION_OF_NEEDED_OPERATIONS>

void calculateInternalStates( )
{

if(bPlainTextInvolved)
{

int i = (top = = 0)?(N_PLAIN_TEXT - 1) : (top - 1);
internalStates[0] = calc(involvedPlainText[i],
internalStates [0]);

}
else

internalStates [0] = linearFunction(internalStates[0]);

for(int i = 1; i < nInternalStates; i ++)
{

internalStates[i] = calc(internalStates[i-1], internalStates[i]);

}

}
int calc(int x, int y)
{

<MULTI_OPERATION_ON_X_Y_SBOX>

}
int encrypt(int key, int x)
{

return <ENCRYPT_OPERATION>;

}
int decrypt(int key, int y)
{

return <DECRYPT_OPERATION>;

}

In an exemplary embodiment, the code generator 216 is responsible for generating new code based on the template. The code generator 216 consists of 3 parts: the template parser, the tag code generator and the writer.

The template parser parses the template file by locating and extracting all tags. The template parser also calls the corresponding tag code generator class for all tags. Next, the tag code generator dynamically generates code for each tag based upon the tag's classification. A feature of the system is that the generating algorithm can be easily replaced or modified. The writer is responsible for replacing the tag with the new code and then writing the result into a new file.

In the exemplary embodiment, each instance of new dynamic code is assigned a new unique name that distinguishes the agent containing that code from other agents. This name is used for agent management and verification. Since the name is only meaningful to the agent's principal, it is sufficient that the name is unique in the agent principal's view. The names are picked and manipulated by the code generator 218.

A stream cipher algorithm is utilized in an exemplary embodiment of the present invention. This algorithm first randomly determines the number of operations (functions), value n, to be used in the key stream routine. Then n functions are randomly selected from a set of functions F. The set of functions may include, for example, functions such as swap, exclusive OR (XOR), and squaresum. To improve efficiency, these functions are grouped together according to their number of operands. Operands are chosen for each operation (function.) The operands may be chosen from the internal states, previous dynamic code data 214 or previous keys. For better efficiency, the internal states, the previous dynamic code and data 214, and the keys are stored in an array in a fixed format. New code is generated by choosing the operations and operands for each set of dynamic code or data and then substituting the generated source code into the template file.

To ensure that a randomly generated encryption routine is decryptable, each function F in the set of functions G, used to generate encryption code has an inverse function F¹ in the inverse set G⁻¹. To produce a randomly generated stream cipher encryption decryption routine, the steps from the above paragraph are followed, but the set G⁻¹ is used instead of set G. A final step (5) is added that constructs the decryption algorithm by applying the appropriate inverse functions in reverse order with regard to the randomly generated encryption routine.

In an alternative exemplary embodiment of the present invention, the dynamic code and data 220 may be secured via a hash algorithm method. This method produces a condensed representation of the dynamic code and data 220 and, optionally, the message to form a message digest. A mobile agent's information content can then, for example, be provided to a signature algorithm which generates or verifies the signature for the information. Signing the message with the digest rather than encrypting the message often improves the efficiency of the process because the message digest is usually much smaller in size than the message. The same hash algorithm may be used by the verifier of a digital signature as is used by the creator of the digital signature. Any change to the or the algorithm used to hash the message in transit produces a different message digest, causing the signature to fail to verify.

This type of authentication is considered secure because it is computationally infeasible to find a message which corresponds to a given message digest, or to find two different messages which produce the same message digest. Any change to a message in transit will, with very high probability, result in a different message digest, and the signature will fail to verify.

Instead of the principal 112 tracking the status and progress of the mobile agent 116, an Agent Monitoring System (AMS) may be employed to monitor the agent. The AMS may be an application running on the same computer as the principal 110, or any other computer that is able to communicate with the agent across the network.

Before the unique mobile agent is released, it is registered with the AMS. The AMS then tracks the mobile agent throughout its lifetime as it travels from host to host over the global information network. The unique mobile agent may, at some point, establish data exchanges with the AMS. These data exchanges may download or upload of information, for example, notifying the agent of additional new hosts to visit, barring the agent from migrating to known malicious hosts, reporting hosts that were visited or sending partial results of the agent's search back to the AMS.

The principal or AMS may employ detection techniques to determine whether a host is malicious. Exemplary malicious host detection algorithms include: (1) specifying a specified time range in which the AMS (or principal 110) expects an arrival conformation communication from the unique mobile agent after it has migrated to a new host and marking the host as malicious if no communication is received in this time range; (2) detecting that the unique mobile agent has prematurely stopped communicating with the AMS or principal; and (3) the AMS or principal determining that an improperly encrypted message has been received from the unique mobile agent.

The functions of dynamically generated encryption code and a limited lifetime may be combined through the use of a dynamically generated one-time password. The idea of one time password is described in an article by L. Lamport entitled “Password Authentication with Insecure Communications,” Communications of the ACM, vol. 24, No. 11, pp 770-772, 1981. It is designed to counter an attack based on eavesdropping of network connections to get login id and password. In order to use one time password mechanism the principal first chooses a password and stores it in the authentication server. The server chooses a number n (something reasonably large) and recursively hashes the password n times (i.e. computes hashⁿ(password) for some hash function) and stores the result in a database on the server along with the unique identifier of the agent and the number n. The number n represents the number of one time password the agent can use i.e., the number of messages that the agent can send before its lifetime expires. With each use the hash function is applied one less time, creating a respectively different password. If the agent sends more than n messages, the principal will ignore them as the lifetime of the agent has expired.

The dynamic code generation for the one-time password can also be applied to generate the hash function that is used by the agent to generate the password. In this instance, rather than dynamically generating a new hash function, it may be desirable to dynamically select a hash function from a group of known functions, perhaps using a pseudo-random number generator in the selection process. The dynamic code generation algorithm may also be applied to select the initial password used to generate the hashed passwords. The password in this example is not necessarily used as a password but may be used as an encryption key to encrypt the data before it is sent to the principal 112 or AMS. Upon receiving the encrypted data, the principal or AMS may look-up the current key based on the unique agent identifier and then apply a decryption function, corresponding to the function used to encrypt the data, to decode the message.

Secure mobile agents have great potential in many areas of secure information gathering. They can be employed as spiders that search through information networks or have embedded ODBC (Open Database Connectivity) messages that safely access databases across unsecured networks. Mobile agents can also be employed to perform travel planning, Internet network monitoring and to find illegal, unlicensed or unregistered copies of software within computers in a corporate environment.

Although illustrated and described above with reference to certain specific embodiments and examples, the present invention is not intended to be limited to the details shown. Rather, various modifications may be made in the details within the scope and range of equivalents of the claims without departing from the invention. For example, as described above, dynamic code generation of cryptographic functions may be used in other applications than mobile agent communication. Any application that resides on a personal computer is susceptible to reverse engineering attacks that, eventually will result in breaking the tamper-resistant features of the applications. If the renewable tamper-resistant cryptographic functions of the subject invention were used for these applications, an attacker would need to break the function each time it is renewed. This results in considerably more work for persons trying to break the code and, so, encourages them to use the applications as they were intended to be used.

If for example, a dynamically generated stream cipher were used to encrypt content that is meant to be stored temporarily and then played, for example, using a personal video recorder such as a TIVO™ or Replay TV™ system. In this application, an application that can decode the dynamic stream cipher may be sent with the content and used by the viewer to decode and display the content. A computer hacker would not benefit greatly from breaking the stream cipher, as the next encrypted content sent to the viewer will use a different dynamically generated cipher.

Furthermore, renewable generated cryptographic functions, as described above, may also be used to verify the identity of a user on an individual computer. Because the cryptographic function is continually being renewed, an attacker will not have continuous access to the protected material. Renewable cryptographic functions may also be useful for ensuring the integrity of log files or audit trails, making it more difficult for a malicious user of a database to hide illegal modifications of the data that were made at different times or different locations.

What is claimed:

1. A method for creating a cryptographic function comprising the steps of:
providing a cryptographic function template having at least one static set of instructions and indicators for at least one dynamic set of instructions;
dynamically generating computer program instructions for the at least one dynamic set of instructions, the dynamically generated instructions being unique to the cryptographic function; and
replacing the indicators for the at least one dynamic set of instructions with the dynamically generated computer program instructions to form the unique cryptographic function.

2. A method according to claim 1, further comprising the step of assigning a unique identifier to the unique cryptographic function.

3. A method according to claim 2, wherein the step of dynamically generating computer program instructions includes the step of selecting a plurality of functions from a predetermined set of functions wherein the stream cipher algorithm sequentially applies the selected functions to encrypt data.

4. A method according to claim 1, wherein the step of dynamically generating computer program instructions includes generating computer program instructions that produce a message digest which is provided with at least one message processed using the unique cryptographic function.

5. A method according to claim 5, wherein the step of generating computer program instructions that produce the message digest includes the step of generating computer program instructions that apply a hash function to at least the dynamically generated code to produce the message digest.

6. A method according to claim 5, wherein the hash function is a stream cipher algorithm and the step of generating computer program instructions that apply the hash function to at least the dynamically generated code includes the step of selecting a plurality of functions from a predetermined set of functions wherein the stream cipher algorithm sequentially applies the selected functions to implement the hash function.

7. A method according to claim 1, further comprising the step of assigning a limited lifetime to the unique cryptographic function.

8. A method according to claim 7, wherein the step of assigning a limited lifetime to the unique cryptographic function assigns a predetermined termination time to the agent.

9. A method according to claim 7, wherein the step of assigning a limited lifetime to the unique cryptographic function assigns a maximum number of messages that may be processed using the function.

10. A method for creating a unique mobile agent comprising the steps of:
providing a mobile agent template having at least one static set of instructions and indicators for at least one dynamic set of instructions;
dynamically generating computer program instructions for the at least one dynamic set of instructions, the dynamically generated instructions being unique to the mobile agent; and
replacing the indicators for the at least one dynamic set of instructions with the dynamically generated computer program instructions to form the unique mobile agent.

11. A method according to claim 10, further comprising the step of assigning a unique identifier to the unique mobile agent.

12. A method according to claim 10, wherein the dynamic set of instructions implement an encryption algorithm.

13. A method according to claim 12, wherein the encryption algorithm is a stream cipher algorithm and the step of dynamically generating computer program instructions includes the step of selecting a plurality of functions from a predetermined set of functions wherein the stream cipher algorithm sequentially applies the selected functions to encrypt data.

14. A method according to claim 10, wherein the step of dynamically generating computer program instructions includes generating computer program instructions that produce a message digest which is provided with at least one message sent processed using the unique cryptographic function.

15. A method according to claim 14, wherein the step of generating computer program instructions that produce the message digest includes the step of generating computer program instructions that apply a hash function to at least the dynamically generated code to produce the message digest.

16. A method according to claim 15, wherein the hash function is a stream cipher algorithm and the step of generating computer program instructions that apply the hash function to at least the dynamically generated code includes the step of selecting a plurality of functions from a predetermined set of functions wherein the stream cipher algorithm sequentially applies the selected functions to implement the hash function.

17. A method according to claim 10, further comprising the step of assigning a limited lifetime to the unique mobile agent.

18. A method according to claim 17, wherein the step of assigning a limited lifetime to the unique mobile agent assigns a predetermined termination time to the agent.

19. A method according to claim 17, wherein the step of assigning a limited lifetime to the unique mobile agent assigns a maximum number of messages that may be sent by the unique mobile agent.

20. A method according to claim 17, wherein the step of assigning a limited lifetime to the unique mobile agent assigns a maximum number of host computers that the unique mobile agent may visit.

21. A method for creating a plurality of unique mobile agents comprising the steps of:
providing a mobile agent template having at least one static set of instructions and indicators for at least one dynamic set of instructions;
dynamically generating a plurality of respectively different sets of computer program instructions for the at least one dynamic set of instructions, for the respective plurality of mobile agents; and
replacing the indicators for the at least one dynamic set of instructions with the respective dynamically generated computer program instructions to generate the plurality of unique mobile agents.

22. A method according to claim 21, further comprising the step of assigning a respectively different identifier to each of the plurality of unique mobile agents.

23. A method according to claim 21, wherein the each of the plurality of dynamic sets of instructions implements a respectively different encryption algorithm.

24. A method according to claim 23, wherein each of the respectively different encryption algorithms is a stream cipher algorithm and the step of dynamically generating computer program instructions includes the step of selecting a respectively different plurality of functions from a predetermined set of functions wherein the stream cipher algorithm sequentially applies the selected functions to encrypt data.

25. A method according to claim 24, wherein the static set of instructions for each unique mobile agent includes instructions which apply the respective encryption algorithm to at least one message sent by the unique mobile agent.

26. A method according to claim 24, wherein the static set of instructions for each unique mobile agent includes instructions which apply the respective encryption algorithm to produce a message digest which is sent with at least one message sent by the unique mobile agent.

27. A method according to claim 21, further comprising the step of assigning a respectively different limited lifetime to each of the plurality of unique mobile agents.

28. A method of monitoring a mobile agent migrating among consumer host computers in a network to detect possibly malicious host computers, the method comprising the steps of:
assigning a limited lifetime of the mobile agent;
registering the mobile agent with an agent monitoring system (AMS);
establishing communication between the mobile and the AMS to determine a sequence of the host computers visited by the mobile agent; and
identifying a last one of the host computers on the network to which the agent migrated as possibly malicious if the AMS is not able to communicate with the mobile agent during the limited lifetime of the mobile agent.

29. A method according to claim 28, wherein the step of assigning a limited lifetime to the mobile agent assigns a maximum number of messages that the mobile agent may send to the AMS

30. A method according to claim 28, wherein the step of assigning a limited lifetime to the mobile agent assigns a maximum number of hosts that the mobile agent may visit.

31. A method according to claim 30, wherein the step of assigning a limited lifetime to the mobile agent assigns a time at which the mobile agent will expire.

32. A method of monitoring a mobile agent migrating among consumer host computers in a network to detect possibly malicious host computers, the method comprising the steps of:
specifying a unique encryption algorithm to the mobile agent;
registering the mobile agent with an agent monitoring system (AMS);
establishing communication between the mobile and the AMS to determine a sequence of the host computers visited by the mobile agent; and
identifying a last one of the host computers on the network to which the agent migrated as possibly malicious if the AMS receives an improperly encrypted message from the mobile agent.

33. A computer readable carrier including computer program instructions that cause a computer to implement a method for creating a cryptographic function, the method comprising the steps of:
providing a cryptographic function template having at least one static set of instructions and indicators for at least one dynamic set of instructions;
dynamically generating computer program instructions for the at least one dynamic set of instructions, the dynamically generated instructions being unique to the cryptographic function; and
replacing the indicators for the at least one dynamic set of instructions with the dynamically generated computer program instructions to form the unique cryptographic function.

34. A computer readable carrier including computer program instructions that cause a computer to implement a method for creating a plurality of unique mobile agents, the method comprising the steps of:
providing a mobile agent template having at least one static set of instructions and indicators for at least one dynamic set of instructions;
dynamically generating a plurality of respectively different sets of computer program instructions for the at least one dynamic set of instructions, for the respective plurality of mobile agents; and
replacing the indicators for the at least one dynamic set of instructions with the respective dynamically generated computer program instructions to generate the plurality of unique mobile agents.

35. A computer readable carrier including computer program instructions that cause a computer to implement a method of monitoring a mobile agent migrating among consumer host computers in a network to detect possibly malicious host computers, the method comprising the steps of:
specifying a unique encryption algorithm to the mobile agent;
registering the mobile agent with an agent monitoring system (AMS);
establishing communication between the mobile and the AMS to determine a sequence of the host computers visited by the mobile agent; and
identifying a last one of the host computers on the network to which the agent migrated as possibly malicious if the AMS receives an improperly encrypted message from the mobile agent.
